(19) United States
(12) Patent Application Publication
(10) Pub. No.: US 2024/0034353 A1
(43) Pub. Date: Feb. 1, 2024

(54) AUTOMATIC GENERATION OF CORNER SCENARIOS DATA FOR TUNING AUTONOMOUS VEHICLES

(71) Applicant: Baidu USA LLC, Sunnyvale, CA (US)

(72) Inventors: Yu CAO, Sunnyvale, CA (US); Weiman LIN, Sunnyvale, CA (US); Shu JIANG, Sunnyvale, CA (US); Szu Hao WU, Sunnyvale, CA (US); Jiangtao HU, Sunnyvale, CA (US)

(21) Appl. No.: 17/815,881

(22) Filed: Jul. 28, 2022

(51) Int. Cl. B60W 60/00; B60W 40/06

(52) U.S. Cl. CPC B60W 60/0011; B60W 40/06

(57) ABSTRACT

Embodiments of the invention are provided to automatically generate corner simulation scenarios. In an embodiment, an exemplary method includes performing the following operations for a predetermined number of iterations for each set of predefined parameters. The operations include generating a set of parameter values for the set of predefined parameters; determining whether the set of parameter values is valid or invalid based on a set of predefined metrics; and if the set of parameter values is valid, performing a simulation task to simulate a trajectory planner of the ADV in a simulation scenario configured by the set of parameter values. The method further includes calculating a performance score for the simulation task; and if the performance score of the simulation task is below a predetermined threshold, saving the set of parameter values in a storage, wherein the set of parameter values is used for re-tuning the trajectory planner.

### TECHNICAL FIELD

Embodiments of the present disclosure relate generally to autonomous driving vehicles. More particularly, embodiments of the disclosure relate to generating corner scenario data for tuning a trajectory planner of an autonomous driving vehicle.

### BACKGROUND

An autonomous driving vehicle (ADV), when driving in an automatic mode, can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

The performance of autonomous vehicle behavior planning has been steadily improving. While a large percentage of planning problems can be solved with existing planning algorithms, it is becoming increasingly important for the autonomous vehicle planner to tackle the long-tail or corner scenarios in order to fully achieve L4 self-driving.

However, the data for such cases are scarce, and thus simulation is often used to evaluate the performance of a trajectory planner in these situations. However, manually configuring such corner scenarios can be time-consuming, and cannot produce data that covers all possible scenarios.

### BRIEF DESCRIPTION OF THE DRAWINGS

Embodiments of the disclosure are illustrated by way of example and not limitation in the figures of the accompanying drawings in which like references indicate similar elements.

FIG. 1 is a schematic diagram illustrating a simulation scenario data generator according to an embodiment of the invention.

FIG. 2 is a flow diagram illustrating a process of generating corner scenarios according to an embodiment of the invention.

FIG. 3 is a flow diagram schematic diagram further illustrating the simulation scenario data generator according to an embodiment of the invention.

FIG. 4 illustrates an example of a simulation platform according to an embodiment of the invention.

FIG. 5 is a flow chart illustrating a process of generating corner scenario data according to an embodiment of the invention.

FIG. 6 is a block diagram illustrating an ADV according to an embodiment of the invention.

FIG. 7 is a block diagram illustrating a control system of the ADV according to an embodiment of the invention.

FIG. 8 is a block diagram illustrating an example of the autonomous driving system of the ADV according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to various embodiments, the disclosure discloses systems, methods and media for automatically generating simulation scenarios for corner cases that are handle well enough by a trajectory planner of an ADV. The generated simulation scenarios can then be used to improve the trajectory planner.

As discussed above, corner scenarios (also referred to as corner case scenarios) can be rarely-encountered driving scenarios (e.g., an ADV going against the traffic) in the real world and data for such driving scenarios is scarce, making training a trajectory planner of the ADV challenging.

Embodiments of the invention are provided to automatically generate corner simulation scenarios by varying values of configuration parameters of predefined driving scenarios. In an embodiment, an exemplary method includes performing the following operations for a predetermined number of iterations for each set of predefined parameters. The operations include generating a set of parameter values for the set of predefined parameters; determining whether the set of parameter values is valid or invalid based on a set of predefined metrics; and if the set of parameter values is valid, performing a simulation task to simulate a trajectory planner of the ADV in a simulation scenario configured by the set of parameter values. The method further includes calculating a performance score for the simulation task; and if the performance score of the simulation task is below a predetermined threshold, saving the set of parameter values in a storage, wherein the set of parameter values is used for re-tuning the trajectory planner.

In an embodiment, the method further includes using the set of parameter values to guide the simulation scenario data generator in generating parameter values in a next iteration in response to determining that the set of parameter values is invalid. The set of parameter values in each of the predetermined number of iterations can be generated by taking a different value from within a search space of each parameter of the set of predefined parameters. The different value from within the search space of each parameter of the set of predefined parameters can be taken based on a predetermined search algorithm, which can be one of a random search algorithm, a grid search algorithm, or a Bayesian algorithm. The number of predetermined iterations and the predetermined search algorithm can be defined by a tuning configuration file defined users based on needs.

In an embodiment, configuring the simulation scenario using the set of parameter values comprises injecting the set of parameter values into a simulation scenario schema to generate a simulation scenario configuration file; and then configuring the simulation scenario using the simulation scenario configuration file.

In an embodiment, the calculating of the performance score for the simulation task comprises calculating a weighted score for each of multiple simulations in the simulation task to obtain multiple weighted scores, the weighted score measuring a performance of the trajectory planner of the ADV in one of the multiple simulations; and averaging the multiple weighted scores to obtain the performance score for the simulation task. The weighted score for each simulation is calculated based on a predetermined weight of each metric in a set of performance metrics.

Thus, the various embodiments in this disclosure can be used to search all possible values within search spaces of scenario configuration parameters, and to identify multiple sets of parameter values representing valid simulation scenarios, and one or more sets of parameter values representing invalid simulation scenarios (e.g., a set of parameter values representing a simulation scenario in which an obstacle vehicle fly in the air). The valid parameter value sets can be converted to simulation scenario configuration files for use in configuring simulation scenarios in a simulation service, where the performance of the trajectory planner of the ADV can be simulated in the configured simulation scenarios. Simulation scenarios in which the trajectory planner fails can be identified based on a comparison between a threshold performance score and a performance score of the trajectory planner in each simulation scenario. The identified simulation scenarios can be identified as corner scenarios, which can be used to improve the planning algorithm of the trajectory planner.

The embodiments described above are not exhaustive of all aspects of the present invention. It is contemplated that the invention includes all embodiments that can be practiced from all suitable combinations of the various embodiments summarized above, and also those disclosed below.

### Corner Scenario Data Generation

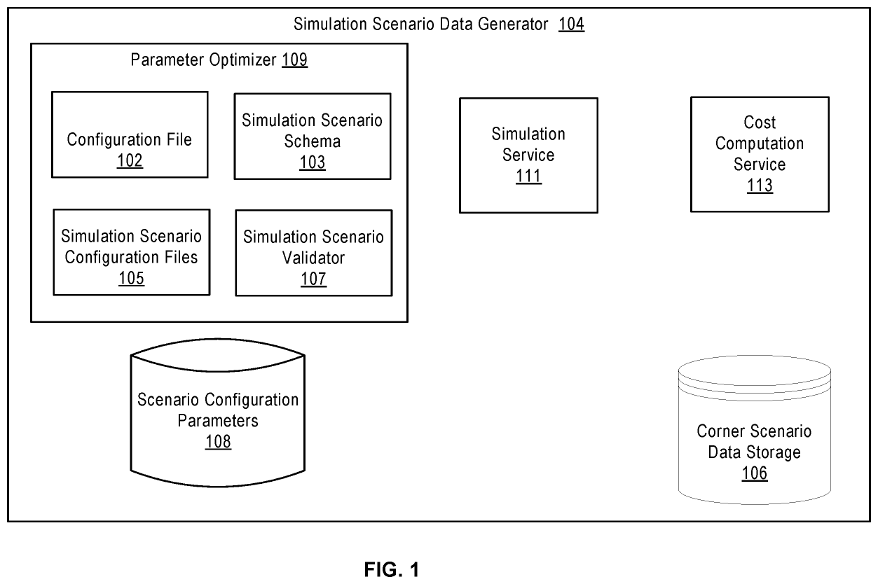

FIG. 1 is a schematic diagram illustrating a simulation scenario data generator 104 according to an embodiment of the invention. The simulation scenario data generator 104 can be implemented in software, hardware or a combination thereof, and can run on one or more physical host machines, and can be cloud-based or on-premises.

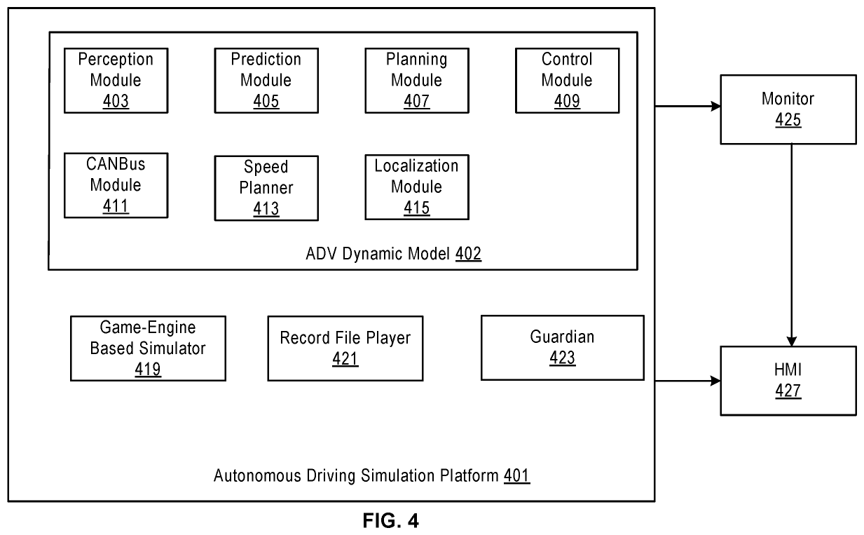

The simulation scenario data generator 104 can include a parameter optimizer 109, a simulation service 111, and a cost computation service 113. The parameter optimizer 109 can sample a different parameter value in a configured search space of each parameter in a set of parameters created to represent a driving scenario. The simulation service 111 can be a web-based simulation platform, such as the DREAMLAND™ simulation platform provided by BAIDU™, or another simulation platform described in detail in FIG. 4. The cost computation service 113 can calculate a score for each simulation task based on a set of metrics to measure the performance of a trajectory planner of a simulated vehicle in a particular simulation scenario.

As further shown, the parameter optimizer 109 includes a tuning configuration file 102, a simulation scenario schema 103, one or more simulation scenario configuration files 105, and a simulation scenario validator 107. The tuning configuration file 102 can be defined by users to specify how the parameter optimizer 109 should vary values in search spaces of different parameters to generate different sets of parameter values, and a number of iterations of the parameter optimizer 109.

The simulation scenario schema 103 can be a user-defined template or data model for creating one of the simulation scenario configuration file 105. In an embodiment, a set of parameter values can be injected into the simulation scenario schema 103 to create one of the simulation scenario configuration files 105.

Each simulation scenario configuration file 105 can define a simulation scenario in the simulator service 111. While a real-world driving scenario can be defined by map information and/or traffic information, a simulation scenario in this disclosure is defined by a scenario configuration file with a set of parameter values describing behaviors of each actor and attributes of static objects in the simulation scenario. Examples of actors of a simulation scenario can include an ego vehicle, an obstacle vehicle pedestrian; and examples of static objects can include stops signs, traffic lights, buildings, mailboxes on the road side. The behaviors of each actor and the attributes of each static object can be described using a range of values.

In an embodiment, multiple sets of parameters representing predetermined driving scenarios can be retrieved from a scenario configuration parameters database 108. The parameter sets can be manually configured, extracted from road test data, or obtained from another source.

For example, at least some of the parameter sets can be obtained using the following process: First, real-world driving scenarios are manually selected from recorded data collected during real-world test drives. Examples of the driving scenarios can include a left turn, a right turn, a junction, a straight lane, and pedestrians crossing in front of the ego vehicle suddenly, and waiting for traffic lights. Second, annotation tools can be used to extract and localize different actors (vehicles, pedestrians, etc.) and static objects in each driving scenario. Third, these driving scenarios are parameterized in terms of map information, and traffic information.

For example, a right turn driving scenario can be parameterized with the following set of parameters, which can include, but not limited to, a number of lanes in the road that the ego vehicle is on, a position of the lane in which the ego vehicle is located, a duration of the traffic lights, a color of the traffic lights, and an angle of the curb that the ego needs to navigate, a speed of each surrounding vehicle, a number of pedestrians crossing the road in front of the ego vehicle, a speed of the ego vehicle, a heading of the ego vehicle, and a position of the vehicle. Further, other information, such as weather information, can be parameterized and added to the above parameter list. For example, parameters related to the weather can include the type of weather (e.g., sunny, snowing, raining), a visibility distance, and road conditions (e.g., slippery, dry, muddy).

Each parameter in a set of parameters representing a driving scenario can have a range of values that can be sampled by the parameter optimizer 109. The sampled values from the value range of each parameter constitute a set of parameter values, which can be injected into the simulation scenario schema 103 to create one of the simulation scenario configuration files 105.

In an embodiment, for each set of parameters, the parameter optimizer 109 can create multiple sets of parameter values in parallel in a single iteration. Each set of parameters can be validated by the simulation scenario validator 107 based on a set of predetermined metrics defined by users. For example, in a driving scenario involving one or more surrounding obstacles, none of the surrounding obstacles should be positioned above the ego vehicle—a surrounding vehicle should not be flying in the air. Thus, any parameter value set with a surrounding vehicle positioned above the ego vehicle should be invalidated. Each set of parameters can have its own set of metrics, or multiple sets of parameters in the scenario configuration parameters database 108 can share one set of metrics.

If a set of scenario parameters is invalid, it can be used by the parameter optimizer 109 to guide its parameter value search in future iterations. If a set of parameter values is valid, it can be injected into the simulation scenario schema 106 to create a scenario configuration file for the simulation service 111 to perform a simulation task in a simulation scenario defined by the scenario configuration file.

Each simulation task can include a fixed number of simulations using a set of parameter values. A weighted performance score for each of the fixed number of simulations can be calculated based on a set of performance metrics, and a performance score as an average of all the weighted scores from the fixed number of simulations for the simulation task can be used to determine whether the existing trajectory planner of the ADV can handle the simulation scenario defined by the corresponding simulation scenario configuration file. If the performance score does not exceed a predetermined threshold, the existing trajectory planner of the ADV cannot handle the simulation scenario corresponding to the set of parameter values; otherwise, it can handle the simulation scenario.

If the simulation scenario cannot be handled by the existing trajectory planner, the set of parameter values and/or the corresponding scenario configuration file can be stored in a corner scenario data storage 106.

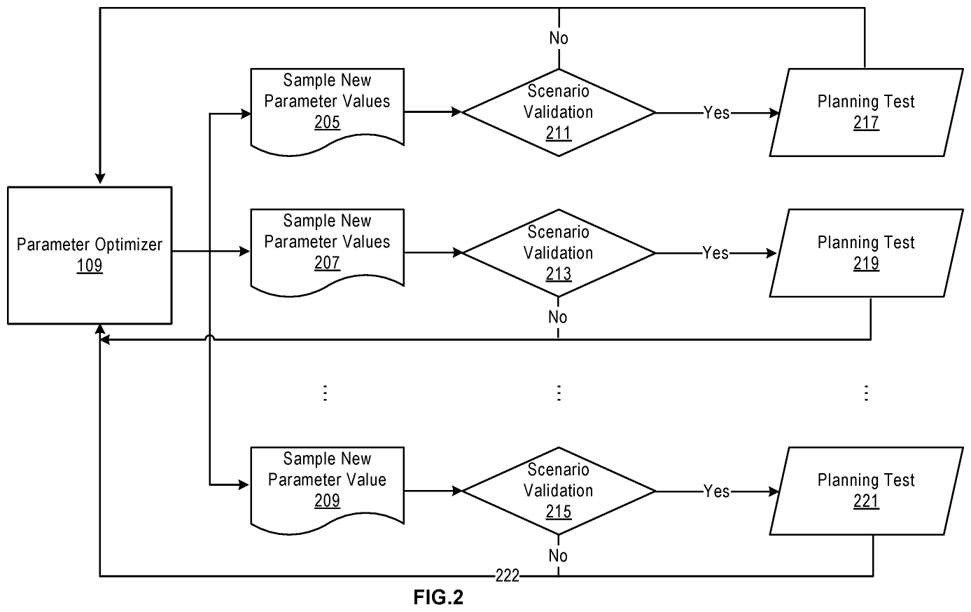

FIG. 2 is a flow diagram illustrating a process of generating corner scenarios according to an embodiment of the invention. In this embodiment, the parameter optimizer 109 can vary values of each parameter in a parameter set within a search space defined by the tuning configuration file 102.

For example, for the parameter of “speed”, the search space can be 0 m/s to 20 m/s; for the parameter of “color of the traffic lights”, the search space can be values representing the colors “red”, “green”, and “yellow”; and for the parameter of “position of a surrounding vehicle”, the search space can include positions above the ego vehicle, behind the ego vehicle, in front of the ego vehicle, and on both sides of the ego vehicle.

In an embodiment, the parameter optimizer 109 can spawn multiple threads to create multiple sets of parameter values 205, 207 and 209 in parallel for each set of parameters. Each of the multiple sets of parameter values 205, 207, and 209 can be validated via validation operations 211, 213, and 215 performed by the simulation scenario validator 107 described in FIG. 1. Each set of the parameter values 205, 207, and 209 can be directly validated, or can be converted into a simulation scenario configuration file first based on the simulation scenario schema 103, and then get validated.

In an embodiment, a validation operation examines each set of parameter values to determine whether the set of parameter values may represent a simulation scenario that is not realistic in the real world based on a set of predefined criteria. For example, in a valid simulation scenario, a surrounding vehicle should not fly in the air, drive towards a tree, or go off the road. As a result, any set of parameter values that defines one of such simulation scenarios would be invalidated.

In an embodiment, a set of invalidated (invalid) parameter values can be sent to the parameter optimizer 109, which can use the set of invalidated parameters as a reference in a next iteration to avoid generating a parameter value set with values that may cause the parameter value set to be invalidated.

In an embodiment, each set of validated (valid) parameter values can be sent to the simulator service 111 for a planning test 217, 219, or 221 after being injected into one of the simulation scenario configuration files 105. A planning test is a simulation task that tests the performance of a trajectory planner of a simulated vehicle in a validated simulation scenario. The performance result of the trajectory planner in the validated simulation scenario can be compared against a threshold value to determine whether the trajectory planner fails or succeeds in the planning tests 217, 219, and 221.

In an embodiment, the performance result of the trajectory planner of the simulated vehicle (e.g., an ADV) can be represented by a performance score, which can be an average of multiple weighted scores, each of which is calculated based on a set of performance metrics in a number of categories, with each performance metric given a predetermined weight.

For example, the performance metrics can fall into the categories of latency, controllability, comfort, and safety. The metrics for measuring latency can include a zig-zag trajectory latency and a stage completed time. The metrics for controllability can include a non-gear-switch trajectory length ratio, an initial heading difference ratio, a normalized curvature ration, a curvature changing rate ratio, an acceleration ratio, a deceleration ratio, and a longitudinal jerk ratio. The metrics for measuring conform can include a longitudinal jerk ratio, lateral jerk ratio, a longitudinal acceleration ratio, a lateral acceleration ratio, a longitudinal deceleration ratio, a lateral deceleration ration, a distance to boundary ratio, a distance to obstacle ratio, and a time to collision ratio. The metrics for measuring safety can include a distance to obstacle ratio, and a time to collision ratio. The above features are provided for the purpose of illustration. Different metrics or additional metrics can be used for each category.

If the trajectory planner fails in a planning test, the set of parameter values and/or the simulation scenario configuration file used for the planning test can be saved in the storage 106 of FIG. 1 for use in tuning the trajectory planner. The failure of the trajectory planner in the planning test means that the trajectory planner cannot handle this simulation scenario well, and thus needs to be re-trained (if the trajectory planner is learning-based) or re-configured (if the trajectory planner is rule-based).

For example, as shown in FIG. 2, the set of parameter values 209 fails in the planning test 221 based on the corresponding performance score, the set of parameter values 209 can be marked as representing a corner scenario, and the performance score can indicate 222 the parameter optimizer 109 to use the set of parameter values 209 to re-tune the trajectory planner in a separate and different process.

The above simulation scenario data generation process can be repeated in multiple iterations. Each iteration may identify zero, one or multiple sets of parameter values that the existing trajectory planner cannot handle well. Each set of identified parameter values represents a corner scenario, and can be used to re-tune the trajectory planner.

The trajectory planner in an embodiment can be rule-based, learning-based, or a combination thereof. A rule-based portion can formulate motion planning as constrained optimization problems, and is reliable and interpretable, but its performance heavily depends on how well the optimization problems are formulated with parameters. These parameters are designed for various purposes, such as modeling different scenarios, balancing the weights of each individual objective, and thus require manual fine-tuning for optimal performance. On the other hand, a learning-based trajectory planner can learn from the massive number of human demonstrations to create human-like driving plans, thus avoiding the tedious design process of setting rules and constraints.

If the trajectory planner is learning-based, re-tuning the trajectory planner means re-training a machine-learning model (e.g., a convolutional neural network model) using the collected corner scenario data. If the trajectory planner is rule-based, re-tuning the trajectory planner means adjusting the rules of the trajectory planner.

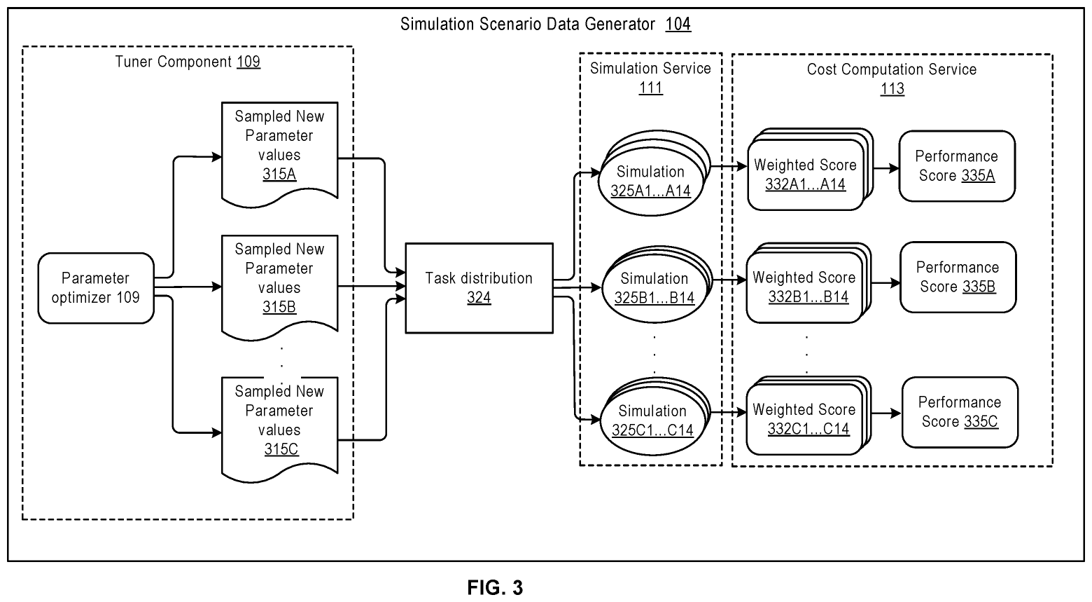

FIG. 3 is a flow diagram schematic diagram further illustrating the simulation scenario data generator 104 according to an embodiment of the invention. To achieve high efficiency, the parameter optimizer 109 supports a parallel process by spawning multiple worker threads to sample different sets of parameter values within predetermined search spaces according to the tuning configuration file 102 as described in FIG. 1. The tuning configuration file 102 can specify a sampling method according to one of many search algorithms, which can include a random search algorithm, a grid search algorithm, or a Bayesian algorithm.

Each set of parameter values can be validated by the simulation scenario validator 107 in FIG. 1. If it is invalidated, it can be used to guide the parameter optimizer 109 in the next round of parameter search. If it is validated, it can be injected into the simulation scenario schema 103 to create a simulation scenario configuration file, which represents a simulation scenario. The simulation scenario configuration file can be sent to a task distribution logic 324, which can distribute the simulation scenario configuration file as a request for a simulation task to the simulation service 111 to execute the simulation task.

Since the tasks distributed by the task distribution logic 324 are independent of each other, another round of efficiency boost is accomplished in the simulation service 111 by running several tasks in parallel in different threads and returning the execution records to the cost computation service 113 separately.

In each simulation task, the same simulation can be executed a number of times (e.g., 14 times), with each execution generating an execution record. The simulation service 111 can execute each simulation in the same simulation scenario corresponding to the same set of parameter values.

Upon receipt of each execution record, the cost computation service 113 calculates a weighted performance score for the execution record based on a weight of each of the performance metrics in the categories of latency, comfort, and controllability. The weighted performance scores for all the execution records for the simulation task can then be averaged to obtain a final performance score for the simulation task.

If the performance score for the simulation task is below a predetermined threshold, the set of parameter values corresponding to the performance score can be collected as a corner scenario for re-tuning the trajectory planner of the simulated vehicle in a different and separate process using an automatic tuning framework.

In an embodiment, the parameter optimizer 109 can iterate a fixed number of times as specified by the tuning configuration file 102 described in FIG. 1. For each iteration, the parameter optimizer 109 can run multiple threads in parallel for efficiency. Each thread can execute the operation of generating a set of new parameters, and zero or more other operations depending on whether the set of new parameter values can be validated or not. The other operations include performing a simulation task to simulate the ADV in the simulation service 111 a number of times; and computing a final performance score.

In FIG. 3, the parameter optimizer 109 generates multiple sets of new parameter values 315A, 315B, and 315C, and all of them are validated. For each set of parameter values, the simulation service 111 can perform a simulation task including 14 simulations, as indicated by 325A1 . . . A14, 325B1 . . . B14, or 325C1 . . . C14. For each simulation task, the cost computation service 112 can compute a performance score 335A, 335B, or 335C, each performance being an average of 14 weighed scores 332A . . . A14, 332B . . . B14, or 332C . . . C14.

FIG. 4 illustrates an example of a simulation platform according to an embodiment of the invention. The simulation platform can be used to provide the simulation service 111.

The simulation platform 401 includes a dynamic model 402 of an ADV, a game-engine based simulator 419 and a record file player 421. The game-engine based simulator 419 can provide a 3D virtual world where sensors can perceive and provide precise ground truth data for every piece of an environment. The record file player 421 can replay record files recorded in the real world for use in testing the functions and performance of various modules of the dynamic model 402.

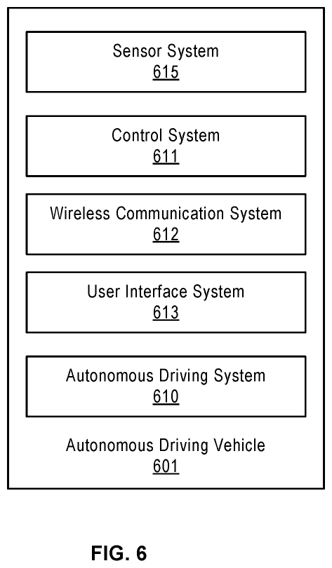

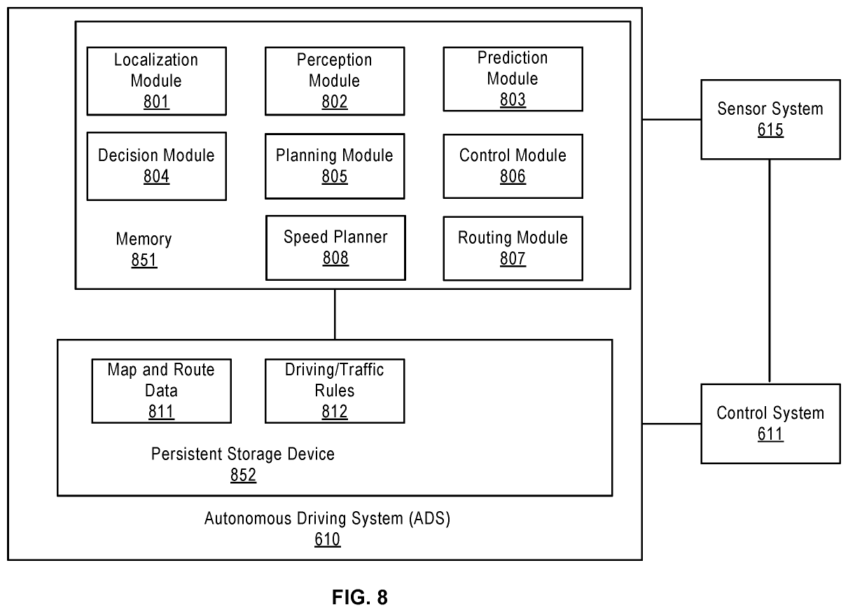

In one embodiment, the ADV dynamic model 402 can be a virtual vehicle that includes a number of core software modules, including a perception module 405, a prediction module 405, a planning module 409, a control module 409, a speed planner module 413, a CAN Bus module 411, a speed planner module 413, and a localization module 415. The functions of these modules are described in detail in FIGS. 6 and 8.

As further shown, the simulation platform 401 can include a guardian module 423, which is a safety module that performs the function of an action center and intervenes when a monitor 425 detects a failure. When all modules work as expected, the guardian module 423 allows the flow of control to work normally. When a crash in one of the modules is detected by the monitor 425, the guardian module 423 can prevent control signals from reaching the CAN Bus 411 and can bring the ADV dynamic model 402 to a stop.

The simulation platform 401 can include a human machine interface (HMI) 427, which is a module for viewing the status of the dynamic model 402, and controlling the dynamic model 402 in real time.

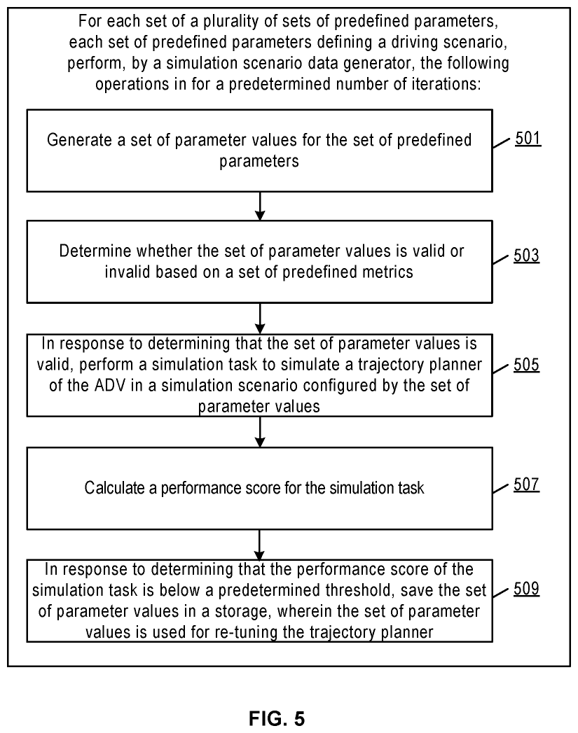

FIG. 5 is a flow chart illustrating a process of generating corner scenario data according to an embodiment of the invention. The process may be performed by processing logic which may include software, hardware, or a combination thereof. For example, the process may be performed by various components and services in the simulation scenario data generator 104 described in FIG. 1.

Referring to FIG. 5, the processing logic performs the following operations for a predetermined number of iterations for each set of a plurality of sets of predefined parameters, each set of predefined parameters defining a driving scenario.

In operation 501, the process logic generates a set of parameter values for the set of predefined parameters. The set of predefined parameters describe behaviors of actors and attributes of static objects in a driving scenario, and can be extracted from road test data and/or manually crated by users.

In operation 503, the processing logic determines whether the set of parameter values is valid or invalid based on a set of predefined metrics by users. A set of invalid parameter values can include one or more parameter values that are not unrealistic in real life. For example, a surrounding vehicle is flying in the air.

In operation 505, the processing logic, in response to determining that the set of parameter values is valid, performs a simulation task to simulate a trajectory planner of the ADV in a simulation scenario configured by the set of parameter values. In the simulation task, a simulation of the ADV defined by the set of parameter values can be repeated a number of times.

In operation 507, the processing logic saves the set of parameter values in a storage in response to determining that the performance score of the simulation task is below a predetermined threshold, and the set of parameter values is used for re-tuning the trajectory planner.

### Automatic Driving Vehicle

FIG. 6 is a block diagram illustrating an autonomous driving vehicle according to an embodiment of the invention. Referring to FIG. 6, autonomous driving vehicle 601 may be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to drive in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 601 can operate in a manual mode, a full autonomous mode, or a partial autonomous mode.

In one embodiment, autonomous driving vehicle 601 includes, but is not limited to, autonomous driving system (ADS) 610, vehicle control system 611, wireless communication system 612, user interface system 613, and sensor system 615. Autonomous driving vehicle 601 may further include certain common components included in ordinary vehicles, such as, an engine, wheels, steering wheel, transmission, etc., which may be controlled by vehicle control system 611 and/or ADS 610 using a variety of communication signals and/or commands, such as, for example, acceleration signals or commands, deceleration signals or commands, steering signals or commands, braking signals or commands, etc.

Components 610-615 may be communicatively coupled to each other via an interconnect, a bus, a network, or a combination thereof. For example, components 610-615 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

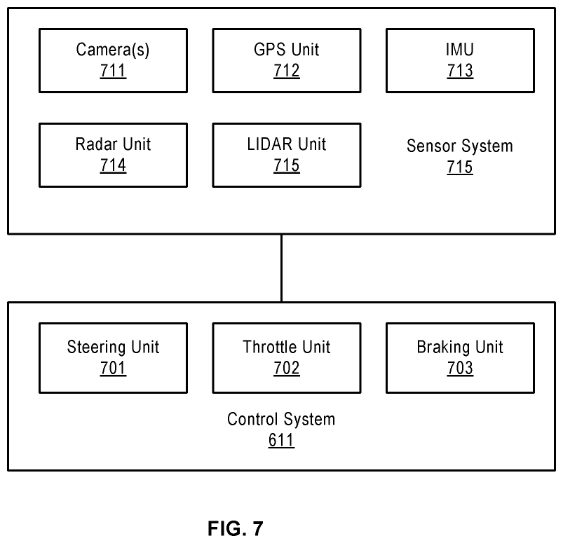

Referring now to FIG. 7, in one embodiment, sensor system 615 includes, but it is not limited to, one or more cameras 711, global positioning system (GPS) unit 712, inertial measurement unit (IMU) 713, radar unit 714, and a light detection and range (LIDAR) unit 715. GPS system 712 may include a transceiver operable to provide information regarding the position of the autonomous driving vehicle. IMU unit 713 may sense position and orientation changes of the autonomous driving vehicle based on inertial acceleration. Radar unit 714 may represent a system that utilizes radio signals to sense objects within the local environment of the autonomous driving vehicle. In some embodiments, in addition to sensing objects, radar unit 714 may additionally sense the speed and/or heading of the objects. LIDAR unit 715 may sense objects in the environment in which the autonomous driving vehicle is located using lasers. LIDAR unit 715 could include one or more laser sources, a laser scanner, and one or more detectors, among other system components. Cameras 711 may include one or more devices to capture images of the environment surrounding the autonomous driving vehicle. Cameras 711 may be still cameras and/or video cameras. A camera may be mechanically movable, for example, by mounting the camera on a rotating and/or tilting a platform.

Sensor system 615 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 611 includes, but is not limited to, steering unit 701, throttle unit 702 (also referred to as an acceleration unit), and braking unit 703. Steering unit 701 is to adjust the direction or heading of the vehicle. Throttle unit 702 is to control the speed of the motor or engine that in turn controls the speed and acceleration of the vehicle. Braking unit 703 is to decelerate the vehicle by providing friction to slow the wheels or tires of the vehicle. Note that the components as shown in FIG. 7 may be implemented in hardware, software, or a combination thereof.

Referring back to FIG. 6, wireless communication system 612 is to allow communication between autonomous driving vehicle 601 and external systems, such as devices, sensors, other vehicles, etc. For example, wireless communication system 612 can wirelessly communicate with one or more devices directly or via a communication network. Wireless communication system 612 can use any cellular communication network or a wireless local area network (WLAN), e.g., using WiFi to communicate with another component or system. Wireless communication system 612 could communicate directly with a device (e.g., a mobile device of a passenger, a display device, a speaker within vehicle 601), for example, using an infrared link, Bluetooth, etc. User interface system 613 may be part of peripheral devices implemented within vehicle 601 including, for example, a keyboard, a touch screen display device, a microphone, and a speaker, etc.

Some or all of the functions of autonomous driving vehicle 601 may be controlled or managed by ADS 610, especially when operating in an autonomous driving mode. ADS 610 includes the necessary hardware (e.g., processor(s), memory, storage) and software (e.g., operating system, planning and routing programs) to receive information from sensor system 615, control system 611, wireless communication system 612, and/or user interface system 613, process the received information, plan a route or path from a starting point to a destination point, and then drive vehicle 601 based on the planning and control information. Alternatively, ADS 610 may be integrated with vehicle control system 611.

For example, a user as a passenger may specify a starting location and a destination of a trip, for example, via a user interface. ADS 610 obtains the trip related data. For example, ADS 610 may obtain location and route data from an MPOI server. The location server provides location services and the MPOI server provides map services and the POIs of certain locations. Alternatively, such location and MPOI information may be cached locally in a persistent storage device of ADS 610.

While autonomous driving vehicle 601 is moving along the route, ADS 610 may also obtain real-time traffic information from a traffic information system or server (TIS). Note that the servers may be operated by a third party entity. Alternatively, the functionalities of the servers may be integrated with ADS 610. Based on the real-time traffic information, MPOI information, and location information, as well as real-time local environment data detected or sensed by sensor system 615 (e.g., obstacles, objects, nearby vehicles), ADS 610 can plan an optimal route and drive vehicle 601, for example, via control system 611, according to the planned route to reach the specified destination safely and efficiently.

FIG. 8 is a block diagram illustrating an example of the autonomous driving system 710 according to an embodiment of the invention. The autonomous driving system 710 may be implemented as a part of autonomous driving vehicle 701 of FIG. 7 including, but is not limited to, ADS 710, control system 711, and sensor system 715.

Referring to FIG. 8, ADS 710 includes, but is not limited to, localization module 801, perception module 802, prediction module 803, decision module 804, planning module 805, control module 806, routing module 807, speed planner module 808. These modules and the modules described in FIG. 6 perform similar functions.

Some or all of modules 801-808 may be implemented in software, hardware, or a combination thereof. For example, these modules may be installed in persistent storage device 852, loaded into memory 851, and executed by one or more processors (not shown). Note that some or all of these modules may be communicatively coupled to or integrated with some or all modules of vehicle control system 711 of FIG. 7. Some of modules 801-808 may be integrated together as an integrated module.

Localization module 801 determines a current location of autonomous driving vehicle 701 (e.g., leveraging GPS unit 812) and manages any data related to a trip or route of a user. Localization module 801 (also referred to as a map and route module) manages any data related to a trip or route of a user. A user may log in and specify a starting location and a destination of a trip, for example, via a user interface. Localization module 801 communicates with other components of autonomous driving vehicle 701, such as map and route data 811, to obtain the trip related data. For example, localization module 801 may obtain location and route data from a location server and a map and POI (MPOI) server. A location server provides location services and an MPOI server provides map services and the POIs of certain locations, which may be cached as part of map and route data 811. While autonomous driving vehicle 701 is moving along the route, localization module 801 may also obtain real-time traffic information from a traffic information system or server.

Based on the sensor data provided by sensor system 715 and localization information obtained by localization module 801, a perception of the surrounding environment is determined by perception module 802. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 802 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 802 can also detect objects based on other sensors data provided by other sensors such as a radar and/or LIDAR.

For each of the objects, prediction module 803 predicts what the object will behave under the circumstances. The prediction is performed based on the perception data perceiving the driving environment at the point in time in view of a set of map/rout information 811 and traffic rules 812. For example, if the object is a vehicle at an opposing direction and the current driving environment includes an intersection, prediction module 803 will predict whether the vehicle will likely move straight forward or make a turn. If the perception data indicates that the intersection has no traffic light, prediction module 803 may predict that the vehicle may have to fully stop prior to enter the intersection. If the perception data indicates that the vehicle is currently at a left-turn only lane or a right-turn only lane, prediction module 803 may predict that the vehicle will more likely make a left turn or right turn respectively.

For each of the objects, decision module 804 makes a decision regarding how to handle the object. For example, for a particular object (e.g., another vehicle in a crossing route) as well as its metadata describing the object (e.g., a speed, direction, turning angle), decision module 804 decides how to encounter the object (e.g., overtake, yield, stop, pass). Decision module 804 may make such decisions according to a set of rules such as traffic rules or driving rules 812, which may be stored in persistent storage device 852.

Routing module 807 is configured to provide one or more routes or paths from a starting point to a destination point. For a given trip from a start location to a destination location, for example, received from a user, routing module 807 obtains route and map information 811 and determines all possible routes or paths from the starting location to reach the destination location. Routing module 807 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 804 and/or planning module 805. Decision module 804 and/or planning module 805 examine all of the possible routes to select and modify one of the most optimal routes in view of other data provided by other modules such as traffic conditions from localization module 801, driving environment perceived by perception module 802, and traffic condition predicted by prediction module 803. The actual path or route for controlling the ADV may be close to or different from the reference line provided by routing module 807 dependent upon the specific driving environment at the point in time.

Based on a decision for each of the objects perceived, planning module 805 plans a path or route for the autonomous driving vehicle, as well as parameter values (e.g., distance, speed, and/or turning angle), using a reference line provided by routing module 807 as a basis. That is, for a given object, decision module 804 decides what to do with the object, while planning module 805 determines how to do it. For example, for a given object, decision module 804 may decide to pass the object, while planning module 805 may determine whether to pass on the left side or right side of the object. Planning and control data is generated by planning module 805 including information describing how vehicle 801 would move in a next moving cycle (e.g., next route/path segment). For example, the planning and control data may instruct vehicle 712 to move 10 meters at a speed of 30 miles per hour (mph), then change to a right lane at the speed of 25 mph.

Speed planner 808 can be part of planning module 805 or a separate module. Given a planned trajectory, speed planner 808 guides the ADV to traverse along the planned path with a sequence of proper speeds v=[vᵢ, . . . ]∈[0, N], where vᵢ=dsᵢ/dt and dsᵢ is the traverse distance along the path at t=i and dt is the sampling time.

Based on the planning and control data, control module 806 controls and drives the autonomous driving vehicle, by sending proper commands or signals to vehicle control system 711, according to a route or path defined by the planning and control data. The planning and control data include sufficient information to drive the vehicle from a first point to a second point of a route or path using appropriate vehicle settings or parameter values (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 805 plans a next route segment or path segment, for example, including a target position and the time required for the ADV to reach the target position. Alternatively, planning module 805 may further specify the specific speed, direction, and/or steering angle, etc. In one embodiment, planning module 805 plans a route segment or path segment for the next predetermined period of time such as 5 seconds. For each planning cycle, planning module 805 plans a target position for the current cycle (e.g., next 5 seconds) based on a target position planned in a previous cycle. Control module 806 then generates one or more control commands (e.g., throttle, brake, steering control commands) based on the planning and control data of the current cycle.

Note that decision module 804 and planning module 805 may be integrated as an integrated module. Decision module 804/planning module 805 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 713. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 713. The PNC layer may include functionalities of at least planning module 805 and control module 806. The perception layer may include functionalities of at least perception module 802. In one embodiment, there is an additional layer including the functionalities of prediction module 803 and/or decision module 804. Alternatively, such functionalities may be included in the PNC layer and/or the perception layer. The firmware layer may represent at least the functionality of sensor system 715, which may be implemented in a form of a field programmable gate array (FPGA). The hardware layer may represent the hardware of the autonomous driving vehicle such as control system 711. The application layer, PNC layer, and perception layer can communicate with the firmware layer and hardware layer via the device driver layer.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the operation and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of generating scenario data for tuning an autonomous driving vehicle (ADV), comprising:
for each set of a plurality of sets of predefined parameters, each set of predefined parameters defining a driving scenario, performing, by a simulation scenario data generator, the following operations in for a predetermined number of iterations:
generating a set of parameter values for the set of predefined parameters;
determining whether the set of parameter values is valid or invalid based on a set of predefined metrics;
in response to determining that the set of parameter values is valid, performing a simulation task to simulate a trajectory planner of the ADV in a simulation scenario configured by the set of parameter values;
calculating a performance score for the simulation task;
in response to determining that the performance score of the simulation task is below a predetermined threshold, saving the set of parameter values in a storage, wherein the set of parameter values is used for re-tuning the trajectory planner.

2. The computer-implemented method of claim 1, further comprising:
in response to determining that the set of parameter values is invalid, using the set of parameter values to guide the simulation scenario data generator in generating parameter values in a next iteration.

3. The computer-implemented method of claim 1, wherein the plurality of sets of predefined parameters are extracted from road test data.

4. The computer-implemented method of claim 1, wherein the set of parameter values in each of the predetermined number of iterations is generated by taking a different value from within a search space of each parameter of the set of predefined parameters.

5. The computer-implemented method of claim 4, wherein the different value from within the search space of each parameter of the set of predefined parameters is taken based on a predetermined search algorithm.

6. The computer-implemented method of claim 5, wherein the predetermined search algorithm is one of a random search algorithm, a grid search algorithm, or a Bayesian algorithm.

7. The computer-implemented method of claim 6, wherein the number of predetermined iterations and the predetermined search algorithm are defined by a tuning configuration file.

8. The computer-implemented method of claim 1, wherein configuring the simulation scenario using the set of parameter values comprises:
injecting the set of parameter values into a simulation scenario schema to generate a simulation scenario configuration file; and
configuring the simulation scenario using the simulation scenario configuration file.

9. The computer-implemented method of claim 1, wherein the calculating of the performance score for the simulation task comprises:
calculating a weighted score for each of a plurality of simulations in the simulation task to obtain a plurality of weighted scores, the weighted score measuring a performance of the trajectory planner of the ADV in one of the plurality of simulations;
averaging the plurality of weighted scores to obtain the performance score for the simulation task.

10. The computer-implemented method of claim 9, wherein the weighted score for each of the plurality of simulations is calculated based on a predetermined weight of each of a plurality of performance metrics.

11. A non-transitory machine-readable medium having instructions stored therein, which when executed by a processor of a tuner core, cause the processor to perform operations of generating scenario data for tuning an autonomous driving vehicle (ADV), the operations comprising:
for each set of a plurality of sets of predefined parameters, each set of predefined parameters defining a driving scenario, performing, by a simulation scenario data generator, the following operations in for a predetermined number of iterations:
generating a set of parameter values for the set of predefined parameters;
determining whether the set of parameter values is valid or invalid based on a set of predefined metrics;
in response to determining that the set of parameter values is valid, performing a simulation task to simulate a trajectory planner of the ADV in a simulation scenario configured by the set of parameter values;
calculating a performance score for the simulation task;
in response to determining that the performance score of the simulation task is below a predetermined threshold, saving the set of parameter values in a storage, wherein the set of parameter values is used for re-tuning the trajectory planner.

12. The non-transitory machine-readable medium of claim 11, wherein the operations further comprise:
in response to determining that the set of parameter values is invalid, using the set of parameter values to guide the simulation scenario data generator in generating parameter values in a next iteration.

13. The non-transitory machine-readable medium of claim 11, wherein the plurality of sets of predefined parameters are extracted from road test data.

14. The non-transitory machine-readable medium of claim 11, wherein the set of parameter values in each of the predetermined number of iterations is generated by taking a different value from within a search space of each parameter of the set of predefined parameters.

15. The non-transitory machine-readable medium of claim 14, wherein the different value from within the search space of each parameter of the set of predefined parameters is taken based on a predetermined search algorithm.

16. The non-transitory machine-readable medium of claim 15, wherein the predetermined search algorithm is one of a random search algorithm, a grid search algorithm, or a Bayesian algorithm.

17. The non-transitory machine-readable medium of claim 16, wherein the number of predetermined iterations and the predetermined search algorithm are defined by a tuning configuration file.

18. The non-transitory machine-readable medium of claim 11, where configuring the simulation scenario using the set of parameter values comprises:
injecting the set of parameter values into a simulation scenario schema to generate a simulation scenario configuration file; and
configuring the simulation scenario using the simulation scenario configuration file.

19. The non-transitory machine-readable medium of claim 11, wherein the calculating of the performance score for the simulation task comprises:
calculating a weighted score for each of a plurality of simulations in the simulation task to obtain a plurality of weighted scores, the weighted score measuring a performance of the trajectory planner of the ADV in one of the plurality of simulations;
averaging the plurality of weighted scores to obtain the performance score for the simulation task.

20. A data processing system, comprising:
a processor; and
a memory coupled to the processor to store instructions, which when executed by the processor, cause the processor to perform operations of generating scenario data for tuning an autonomous driving vehicle (ADV), the operations including:
for each set of a plurality of sets of predefined parameters, each set of predefined parameters defining a driving scenario, performing, by a simulation scenario data generator, the following operations in for a predetermined number of iterations:
generating a set of parameter values for the set of predefined parameters;
determining whether the set of parameter values is valid or invalid based on a set of predefined metrics;
in response to determining that the set of parameter values is valid, performing a simulation task to simulate a trajectory planner of the ADV in a simulation scenario configured by the set of parameter values;
calculating a performance score for the simulation task;
in response to determining that the performance score of the simulation task is below a predetermined threshold, saving the set of parameter values in a storage, wherein the set of parameter values is used for re-tuning the trajectory planner.
